(19) United States
(12) Patent Application Publication
(10) Pub. No.: US 2002/0071178 A1
(43) Pub. Date: Jun. 13, 2002

(54) Stereoscopic image display apparatus

(76) Inventor: Hiroshi Suganuma, Ibaraki (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/990,237

(22) Filed: Nov. 21, 2001

(30) Foreign Application Priority Data
Nov. 24, 2000 (JP) P2000-358207

(51) Int. Cl. G02B 27/22

(52) U.S. Cl. 359/462

(57) ABSTRACT

A stereoscopic image display apparatus is provided. The apparatus comprises a light source radiating light with a predetermined wavelength range, an one-dimensional spatial modulator including one-dimensionally arranged elements that are independently driven to generate an arbitrary phase distribution, and a scan unit scanning the light from the light source to a predetermined direction, the light having entered into the one-dimensional spatial modulator and having been modulated therein.

### RELATED APPLICATION DATA

This application claims priority to Japanese Patent Application JP 2000-358207, and the disclosure of that application is incorporated herein by reference to the extent permitted by law.

### BACKGROUND OF THE INVENTION

1. Field of the Invention

The present invention relates to a stereoscopic image display apparatus for displaying a stereoscopic image.

2. Description of the Related Art

Various kinds of display apparatus for displaying planar images (two-dimensional images) by radiating light have hitherto been put to practical use. For example, a liquid crystal panel and a digital micro-mirror device (DMD) have been used as a spatial modulator for modulating light to be projected according to a planar image to be displayed in such a display apparatus.

Moreover, research and development of diffraction gratings that can freely be driven by micro-machines have been proceeding in recent years. Bloom et al (U.S. Pat. No. 5,311,360) discloses a display apparatus using such a diffraction grating as a spatial modulator for modulating light to be projected according to a displaying image was submitted and has been widely noticed.

The micro-machine type diffraction grating to be used as a spatial modulator like this is generally called as a Grating Light Valve (GLV), and such a diffraction grating has features such that it can be operated at a higher speed and can be manufactured at a lower cost by using various kinds of semiconductor manufacturing techniques in comparison with a liquid crystal panel and a DMD that have hitherto been used as a spatial modulator.

Accordingly, it is expected that a display apparatus can display a clear and bright image without any discontinuity and can be realized at a low cost when the display apparatus is configured by the use of the GLV.

On the other hand, as for display apparatuses for displaying stereoscopic images (three-dimensional images), though the display apparatuses have hitherto been realized by the use of various systems, many of them have various restrictions such that visual fields are limited within narrow ranges or that special glasses are needed to see, and they have not been put to full-scale practical use yet.

Accordingly, various technologies making it possible to display stereoscopic images in real time by the use of various hologram techniques have been proposed in recent years. As an example of such proposals, there is a display apparatus (U.S. Pat. No. 5,172,251) that uses acousto-optic devices controlled by a computer apparatus or the like as one-dimensional hologram devices (hereafter called computer generated hologram (CGH)) and displays stereoscopic images by scanning one-dimensional stereoscopic images generated by the CGH in horizontal directions and vertical directions.

### SUMMARY OF THE INVENTION

However, in the case where stereoscopic images are displayed by the use of the acousto-optic devices in the way described above, for example, the acousto-optic devices are used as one-dimensional hologram devices by creating a refractive index distribution by the input of ultrasonic waves according to displaying images. However, the displayed images may be distorted as if the displayed image is flowing due to the nature of the ultrasonic waves to be traveling waves. Accordingly, it is necessary to correct the “flowing” distortion of displayed images by the use of, for example, a polygon mirror or a galvano-mirror. In this case, there are problems such that the whole structure of the display apparatus becomes complicated, and further that it is needed to adjust the timing of the correction to be extremely accurate lest time lags should be generated.

Moreover, devices other than the acousto-optic devices are so far difficult to obtain as a spatial modulator that can operate at a high speed and perform the modulation with an abundant amount of information, both the speed and the amount being sufficient to display stereoscopic images, in a display apparatus for displaying the stereoscopic images. The acousto-optic devices have shortcomings of that they are expensive and that high voltages are necessary for driving them.

There is another problem. Enormous amount of information is required for displaying stereoscopic images because it becomes necessary to display precise information in three-dimensional directions. It is not practical at present to control such enormous amount of information. Moreover, because the amount of information to display a stereoscopic image increases by leaps and bounds as the sizes of the images to be displayed become large, display of a large size stereoscopic images becomes very difficult. Besides, in the case where stereoscopic images are displayed as moving picture in real time, the necessary amount of information further jumps up by leaps and bounds, and it becomes necessary to process enormous amount of information at extremely high speed.

Although various kinds of display apparatuses for displaying stereoscopic images have hitherto been proposed, such display apparatuses have many problems mentioned above, and the display apparatuses are not put to practical use yet.

The present invention is made in consideration of the aforesaid situation and problems. It is desired to provide a stereoscopic image display apparatus capable of displaying stereoscopic images at a higher speed and with a simpler structure than can be manufactured at a lower cost.

According to an embodiment of the present invention, a stereoscopic image display apparatus is provided. The stereoscopic image display apparatus comprises a light source radiating light of a wavelength in a predetermined wavelength range; an one-dimensional spatial modulator including one-dimensionally arrayed elements that are independently driven to generate an arbitrary phase distribution; and a scan unit scanning the light from the light source to a predetermined direction, the light having entered into the one-dimensional spatial modulator and having been modulated therein.

The stereoscopic image display apparatus according to the present embodiment, which configured as above, uses the one-dimensional spatial modulator including the independently driven elements as a spatial modulator for modulating light to be projected. Because such one-dimensional spatial modulator may be operated at a extremely high speed, stereoscopic images may be displayed based on a sufficiently abundant amount of information. Moreover, because the stereoscopic image display apparatus displays stereoscopic images by the use of light modulated by the one-dimensional spatial modulator, the overall structure of the apparatus may be simplified, and the manufacturing cost thereof may be lowered. Moreover, the apparatus may express a stereoscopic effect without any special equipment such as special glasses to view stereoscopic image.

Moreover, the stereoscopic image display apparatus of the present embodiment displays stereoscopic images by scanning and radiating the light modulated by the one-dimensional spatial modulator. Thereby, for example, the stereoscopic images may be displayed with only horizontal parallax of the stereoscopic images to be displayed by the renunciation of vertical parallax. By displaying of the stereoscopic images with one directional parallax in such a way, the increase of a necessary amount of information may be suppressed, and an amount of information and a processing time, both necessary for displaying stereoscopic images, may be decreased to a practical level.

Even when the stereoscopic images are displayed with only horizontal parallax as described above, stereoscopic effects may fully be expressed because two human eyes are arrayed in a horizontal direction and more insensitive to vertical parallax than horizontal parallax.

In the stereoscopic image display apparatus according to the present embodiment, the scan unit may scan the light modulated by the one-dimensional spatial modulator in a direction perpendicular to the arraying direction of the elements of the one-dimensional spatial modulator. Accordingly, a larger size of the stereoscopic image may be displayed and a wider viewing field may be ensured by projecting the scanning light that is modulated with the one-dimensional spatial modulator and scanned with the scan unit into the perpendicular direction to the arraying direction of the elements since the one-dimensional spatial modulator with the individually driven elements may be operated in a sufficiently fast speed.

According to another embodiment of the present invention, there is provided a stereoscopic image display apparatus comprising: a light source radiating light of a wavelength in a predetermined wavelength range; a Grating Light Valve device that can independently drive each ribbon-like element to generate an arbitrary phase distribution of the light; a collimator lens making the light modulated by the Grating Light Valve device into parallel ray; a scan unit scanning the parallel ray from the collimator lens; a lens performing Fourier transformation on the scanned ray; and a diffuser panel diffusing the ray Fourier transformed by the lens.

According to the above mentioned embodiment of the present invention, the stereoscopic image display apparatus capable of displaying stereoscopic images in a higher speed may be realized at a lower cost with a simpler structure. Moreover, according to the above mentioned embodiment, an amount of information and a processing time, both being necessary for displaying a stereoscopic image, may be decreased thereby enabling the moving picture display of stereoscopic images in real time.

### BRIEF DESCRIPTION OF THE DRAWINGS

The other objects, features and advantages of the present invention will become more apparent from the following description of the presently preferred exemplary embodiments of the invention taken in conjunction with the accompanying drawings, in which:

FIG. 1 is a mimetic diagram showing a state such that light enters into a GLV being an example of a spatial modulator of the present invention;

FIG. 2 a mimetic diagram showing a state such that the light entered into the GLV being an example of the spatial modulator of the present invention is modulated and reflected;

FIG. 3 is a mimetic diagram for explaining the principle of the present invention by illustrating the scanning of the light modulated by the GLV in a predetermined direction;

FIG. 4 is a schematic diagram of a display apparatus shown as an example of the structure of the stereoscopic image display apparatus according to the present invention;

FIG. 5 is a schematic diagram for illustrating the rotation directions of a first and a second galvano-mirrors of the display apparatus;

FIG. 6 is a mimetic diagram showing an example of a state such that laser beams modulated to one-dimensional wavefronts scan a projection plane in the display apparatus;

FIG. 7 is a mimetic diagram showing another example of a state such that laser beams modulated to one-dimensional wavefronts scan a projection plane in the display apparatus;

FIG. 8 is a schematic block diagram showing a control circuit provided in the display apparatus; and

FIG. 9 is a schematic perspective view of a mirror array shown as an example of a scan mechanism provided in the display apparatus.

### DESCRIPTION OF THE PREFERRED EMBODIMENTS

Hereinafter, the attached drawings are referred while a preferred embodiment of the stereoscopic image display apparatus according to the present invention are described in detail.

One of the features of the present embodiment is to use a micro-machine type one-dimensional spatial modulator as a spatial modulator for modulating light to be projected. Specifically, as such a spatial modulator, a micro-machine type diffraction grating may be used. The micro-machine type diffraction grating is generally called as a Grating Light Valve (GLV) when it is used as a spatial modulator.

The principle employed in the present embodiment is described in the following before the embodiment of the present invention is described.

A GLV comprises a plurality of minute ribbons formed on a substrate. The ribbons may be fabricated with various semiconductor manufacturing techniques. Each ribbon is configured to be able to arbitrary ascend and descend by a piezoelectric device or the like. The GLV with such ribbon structure may be operated to dynamically drive each ribbon to vary its height while light with a predetermined wavelength range is irradiated thereto, thereby constituting a phase type diffraction grating as a whole. That is, the GLV generates the ±1^{st} order (or higher order) diffracted light by receiving irradiation of the light.

Accordingly, an image may be displayed by the following operations: irradiation of light to the GLV; shielding of the 0^{th} order diffracted light; and driving each ribbon of the GLV upwardly and downwardly so as to have the diffracted light blink.

Various display apparatuses for displaying planar images (two-dimensional images) by utilizing the aforesaid characteristics of a GLV have hitherto been intoroduced. When a conventional display apparatus displays a constituent unit (hereinafter referred to as a pixel) of a planar image to be displayed, about six ribbons are used for displaying one pixel. Furthermore, in a group of ribbons corresponding to one pixel, adjoining ribbons are made to ascend or descend alternately.

However, if each ribbon in a GLV may independently be wired to be driven separately, an arbitrary one-dimensional phase distribution may be generated. The GLV structured in such a way may be regarded as a reflection type one-dimensional phase type hologram.

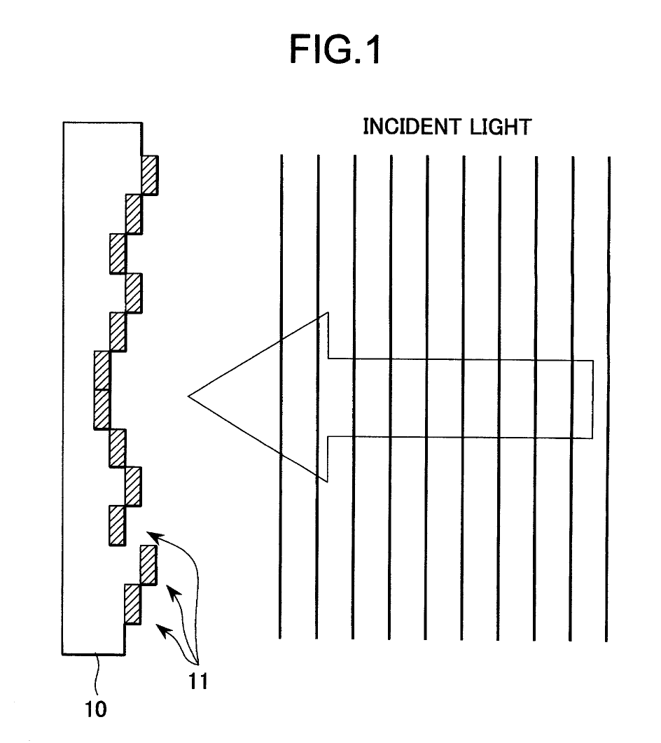

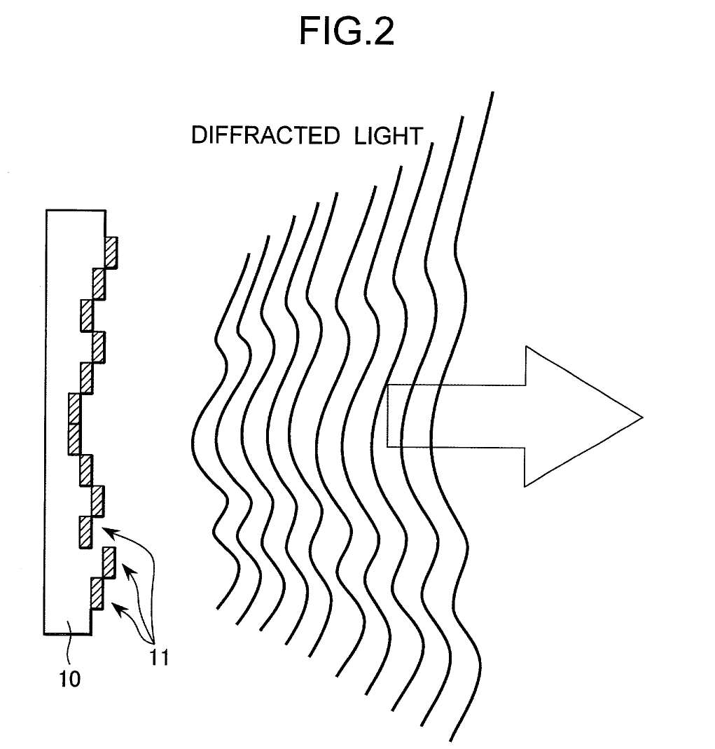

In the present embodiment, the GLV structured as a reflection type one-dimensional phase type hologram in the aforesaid way is used as the micromachine type one-dimensional spatial modulator. That is, for example, as shown in FIG. 1, an arbitrary phase distribution has been generated in advance by the independent driving of each ribbon 11 of a GLV 10. When light with a predetermined wavelength range the phase of which is aligned enters into the GLV 10 from the direction indicated by an arrow in FIG. 1, the incident light is modulated and reflected. Then, as shown in FIG. 2, an arbitrary one-dimensional wavefront may be formed.

Hereupon, a specific example in the case where stereoscopic images are displayed by the use of such GLV is described. In the case where a stereoscopic image is displayed by the use of the GLV in which a plurality of ribbons are one-dimensionally arrayed, each ribbon of the GLV is driven as follows: the Fourier transformation of a function a(x):A(X)=H(X)exp[iö(X)] is calculated when an amplitude of one-dimensional wavefront generated by the GLV is expressed by the a(x) as a function in an x-direction; and then each ribbon of the GLV is driven in such a way that a phase difference corresponding to the phase component ö(X) is given to the reflected light.

In order to be more precise, it is desirable to modulate the amplitude component H(X) as well. Accordingly, more accurate three-dimensional display may be realized. Incidentally, the display apparatus may still be able to display a stereoscopic image with sufficient stereoscopic effects even if the amplitude component H(X) is set to be constant.

When the ribbon in the GLV descends by a depth ∅ from its default position, a change of 2∅ is generated in the optical path length for the reflected light. Accordingly, the phase difference generated by this change is 4δ∅/ë where ë designates the wavelength of the light.

Because the analog modulation of the GLV is possible, a desired phase difference may be given to the reflection light by precise analog driving of the GLV. However, when a display apparatus is structured by the use of such GLV, it is practical to use a discrete calculation method such as the fast Fourier transformation. Accordingly, it is practical to drive each ribbon of the GLV based on a digital signal discretely, and thereby enabling various kinds of signal processing easy.

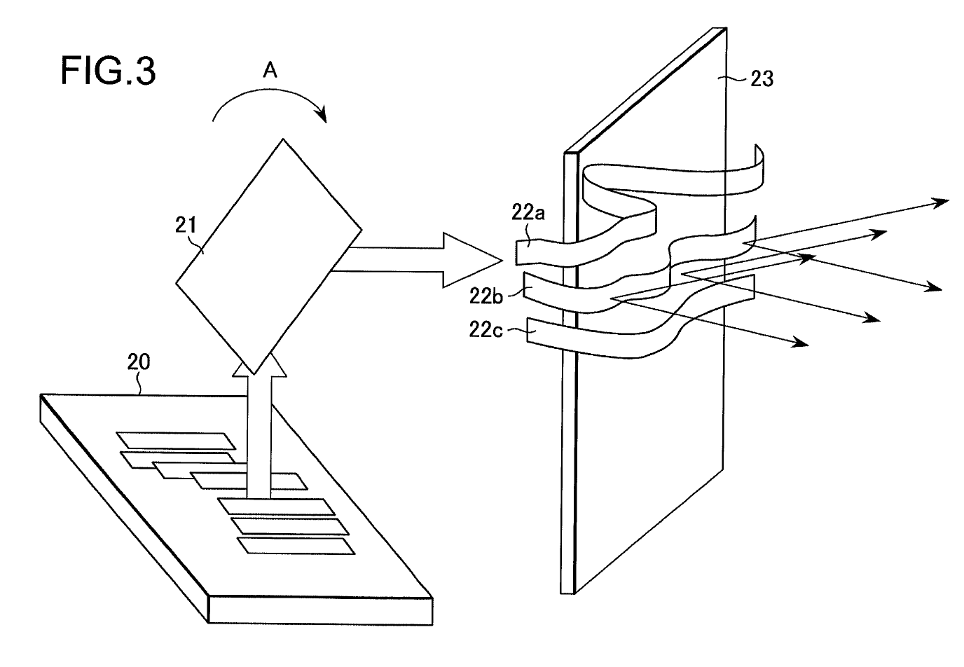

Another embodiment in accordance with the present invention is characterized by displaying stereoscopic images by the use of, for example, a technique shown in FIG. 3 on the basis of the aforesaid principle.

That is, as shown in FIG. 3, a GLV 20 in which a plurality of ribbons are one-dimensionally arrayed generates an one-dimensional wavefront one after another. The generated wavefronts are scanned in a vertical direction by a scan mechanism comprising, for example, a galvano-mirror 21. That is, by the rotation of the galvano-mirror 21 in a direction shown by an arrow A in FIG. 3, a plurality of wavefronts 22a, 22b, 22c are radiated in such a way that they are arranged in the vertical direction. Thereby, a stereoscopic image may be displayed.

As shown in FIG. 3, it is desirable to provide an one-dimensional diffuser panel 23 in the vicinity of a stereoscopic image to be displayed. By the diffuser panel 23, a vertical visual field may be enlarged slightly, and discontinuities between the wavefronts 22a, 22b, 22c are made to be inconspicuous. Accordingly, more natural stereoscopic effects may be expressed.

Now, in the case where stereoscopic images are displayed by the vertical scanning of one-dimensional wavefronts with utilizing the technique shown in FIG. 3, horizontal parallax may sufficiently be secured, but it becomes difficult to obtain vertical parallax as well. Accordingly, such difficulty is addressed in the following.

When a display apparatus is structured by the use of a diffraction grating such as a GLV or a hologram, the relations expressed by the following Equation 1 and Equation 2 are satisfied, where the maximum spatial frequency of the diffraction grating, the shortest period of the grating, a reproduced wavelength, and a diffraction angle (the diffraction angle influences the extent of a visual field) are respectively designated by fₕ, Ë, ë, and è.

fₕ=1/Ë (Equation 1)

fₕë=sin\overline{e} (Equation 2)

According to the sampling theorem, the minimum sampling frequency fₛ may be expressed to meet to the following Equation 3.

fₛ=2fₕ (Equation 3)

Accordingly, a sample number N necessary for reproducing an one-dimensional stereoscopic image having a horizontal length d may be expressed to meet the following Equation 4.

N=d·fₛ=(2d·sinë)/ë (Equation 4)

Moreover, when the vertical resolution of the display apparatus is designated by L, the total number Nₕ of the samples constituting one stereoscopic image may be expressed by the following Equation 5 in the case where the stereoscopic image is displayed by the technique shown in FIG. 3, namely when L pieces of the one-dimensional type diffraction gratings are vertically arranged.

Nₕ=dL·fₛ=(2dL·sinë) /ë (Equation 5)

In order to secure the vertical parallax, a total number Nₕᵥ of the samples necessary for constituting one stereoscopic image may be expressed by the following Equation 6 where the vertical length of the stereoscopic image is designated by w.

Nₕᵥ=(2dw·sin²ë)/ë² (Equation 6)

As being apparent by the comparison of Equation 5 and Equation 6, a required amount of information (the number of samples) remarkably increases when both the horizontal parallax and the vertical parallax are tried to be secured in comparison with that in the case where only the horizontal parallax is secured.

More specifically, when the diffraction angle ë is set to be 30 degrees and the reproduced wavelength ë is set to be 0.5 ìm, the total number Nₕᵥ of the required samples is 2dw×10¹² in conformity with Equation 6. Hereupon, when the horizontal length d and the vertical length w of a stereoscopic image to be displayed are severally set to be 100 mm, the total number Nₕᵥ of the samples necessary for displaying one stereoscopic image is 2×10¹⁰. That is, the amount of information of 20 G bits becomes necessary for displaying one piece of stereoscopic image. Moreover, if 30 stereoscopic images are to be displayed every second for displaying moving picture image, the amount of information of 600 G bits (75 G bytes) becomes necessary every second.

Incidentally, the amount of information of 600 G bits is equal to an amount of information required when the moving picture image is displayed with using monochromatic and no-gradation images. If a color display with the three primary colors is to be performed, an amount of information required is tripled. If eight levels of gradation is to be used, eight times of the information is further required. Furthermore, if displaying is performed on a 12-inch size display apparatus, an amount of information seven times or more is further needed. Accordingly, signal processing dealing with such an enormous amount of information at a high speed is far from being put to practical use at present.

On the other hand, according to the present embodiment, by the use of the technique shown in FIG. 3, a stereoscopic image is displayed only by the horizontal parallax thereof by the relinquishment of the vertical parallax thereof. In this case, similarly to what have been described above, for example, when the diffraction angle e is set to be 30 degrees and the reproduced wavelength e is set to be 0.5 ìm, the total number Nₕᵥ of the required samples is 2dL×10⁶ in conformity with Equation 5. If the horizontal length d and the vertical length w of a stereoscopic image to be displayed are severally set to be 100 mm and the vertical resolution L is set to be 1000, the total number Nₕ of the samples necessary for displaying one piece of stereoscopic image is 2×10⁸. This amount of information is 1/100 in comparison with the aforesaid total sample number Nₕᵥ, i.e. 2×10¹⁰ .

According to the present embodiment using the technique shown in FIG. 3, it becomes possible to decrease an amount of information and a processing time, both being necessary for displaying a stereoscopic image, to a practical level.

Incidentally, even in the case where a stereoscopic image is displayed by the use of the technique shown in FIG. 3, with its vertical parallax being relinquished, because two human eyes exist in a horizontal line, human eyes are more insensitive to the vertical parallax than horizontal parallax, and thereby stereoscopic effects may fully be expressed.

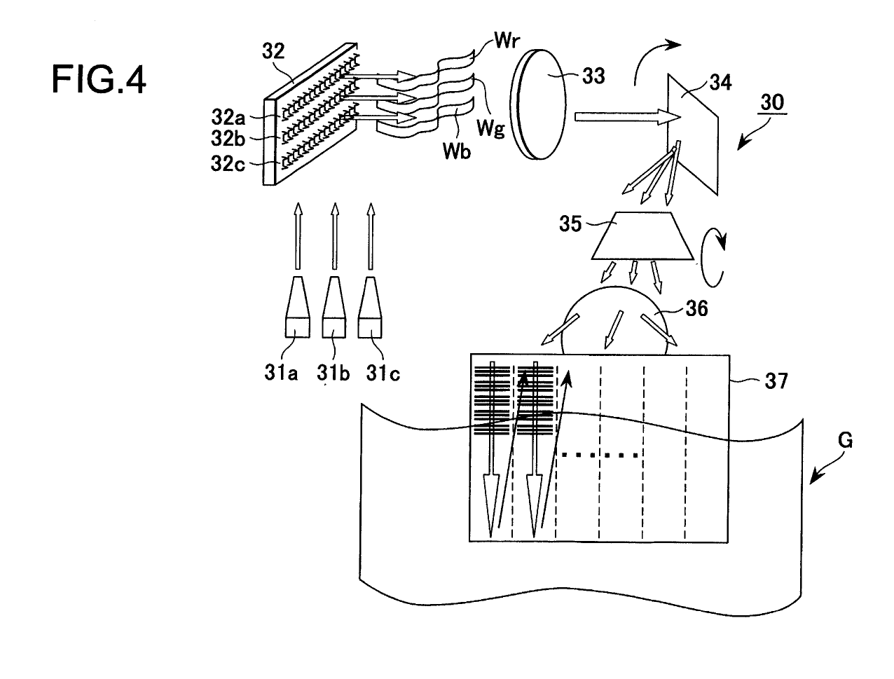

Next, according to still another embodiment of the present invention, a display apparatus 30 shown in FIG. 4 is provided for displaying a stereoscopic image. The display apparatus 30 displays stereoscopic images by scanning and projecting light modulated by a micromachine type one-dimensional spatial modulator by utilizing the aforesaid principle of the present invention.

The display apparatus 30 comprises, as shown in FIG. 4, a first laser oscillator 31a, a second laser oscillator 31b and a third laser oscillator 31c that respectively emits a laser beam in each wavelength range of red, green and blue, respectively. The display apparatus 30 further comprises a GLV 32 for modulating the laser beams emitted from these laser oscillators 31a-31c so as to form one-dimensional wavefronts with respectively desired phase distributions.

Alternatively, other types of coherent light sources such as solid state laser device may be employed in place of the laser oscillators.

The GLV 32 is provided with three ribbon arrays respectively formed from a plurality of minute ribbons that are one-dimensionally arrayed (in a straight line). In the GLV 32, each ribbon is structured to be able to ascend and descend independently and arbitrary by use of a piezoelectric device or the like. These ribbons in the GLV 32 are independently driven by a control circuit that will be described later. Moreover, each ribbon array of the GLV 32 is irradiated by a red laser beam, a green laser beam or a blue laser beam that is respectively radiated from the first, the second or the third laser oscillators 31a, 31b, 31c.

That is, in the GLV 32, a ribbon array 32a for red, a ribbon array 32b for green, and a ribbon array 32c for blue are formed, and the red laser beam, the green laser beam or the blue laser beam is respectively radiated. Then, the GLV 32 one-dimensionally modulates and reflects each laser beam to generate an arbitrary wavefront at every color as red wavefront Wr, green wavefront Wg and blue wavefront Wb shown in FIG. 4. Because respective color wavefronts Wr, Wg, Wb that have been generated in such a way that they travel through substantially the same optical path, each color laser beam is named generically and simply as a laser beam in the following sections of the present specification.

Moreover, the display apparatus 30 comprises a collimator lens 33, a first galvano-mirror 34, a second galvano-mirror 35, a Fourier transformation lens 36 and an one-dimensional diffuser panel 37, all being arranged in order on an optical path of the laser beams reflected by the GLV 32.

The collimator lens 33 allows the laser beams reflected by the GLV 32 to pass through to form parallel rays, and the parallel rays is incident on the first galvano-mirror 34. The first galvano-mirror 34 reflects the incident laser beams to make them incident on the second galvano-mirror 35. The second galvano-mirror 35 reflects the incident laser beams to make them incident on the Fourier transformation lens 36.

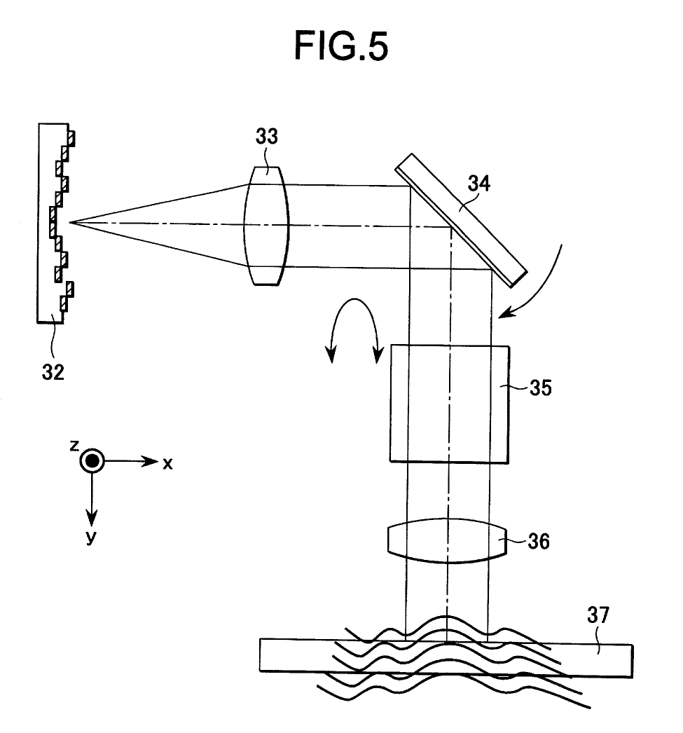

Rotations of the first and the second galvano-mirrors 34, 35 are controlled by a control circuit that will be described later. Assuming an xyz coordinate system as shown in FIG. 5, the first galvano-mirror 34 is controlled to rotate about the z-axis, and the second galvano-mirror 35 is controlled to rotate about the x-axis. That is, the first and the second galvano-mirrors 34, 35 have rotation axes orthogonal to each other, and they are driven to rotate about respective rotation axes under the control of the control circuit.

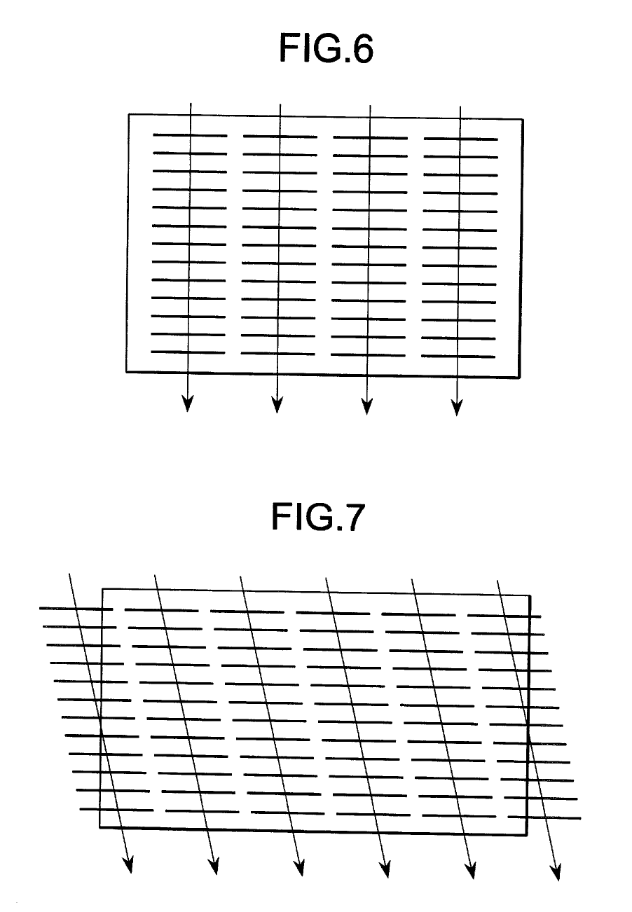

Accordingly, in the display apparatus 30, the laser beams, that have modulated by the GLV 32 and have one-dimensional wavefronts (linear wavefronts), are scanned by the first and the second galvano-mirrors 34, 35 in such a way, for example, shown in FIG. 6. FIG. 6 schematically shows the scanning directions of the laser beams in a projection plane on which stereoscopic images are projected by the display apparatus 30. In the figure, the transverse direction is assumed as the horizontal direction, and the longitudinal direction is assumed as the vertical direction.

That is, in the display apparatus 30, the first and the second galvano-mirrors 34, 35 are driven to rotate by the control circuit, and thereby they can scan the incident laser beams in the horizontal direction and the vertical direction, respectively.

Because the laser beams modulated by the GLV 32 have one-dimensional wavefronts in the display apparatus 30, stereoscopic images may be displayed by the scanning of the laser beams only with the second galvano-mirror 35 in the direction perpendicular to the laser beam wavefronts, i.e. the vertical direction in FIG. 6, without using the first galvano-mirror 34. In this case, the horizontal length of the stereoscopic image to be displayed is restricted by the length of the ribbon arrays 32a, 32b, 32c formed on the GLV 32.

More specifically, when a GLV capable of displaying 1024 pixels is used as the GLV 32 in the display apparatus 30, the number of ribbons formed in each ribbon array 32a, 32b, 32c in the GLV 32 are severally 6144 (in the case where six ribbons are included in one pixel). In the GLV 32, when it is assumed that an interval distance between two neighboring ribbons is 5 ìm, the horizontal length of a stereoscopic image capable of being projected by the display apparatus 30 becomes about 30 mm unless a magnifying lens is used.

Accordingly, it is necessary to increase the number of ribbons of the GLV 32 in order to widen the horizontal length of the stereoscopic image. On the other hand, the yield of manufacturing may be decreased and the manufacturing cost may be increased if the device area of the GLV 32 is to be enlarged.

Because, in the display apparatus 30, the laser beams are scanned by the first and the second galvano-mirrors 34, 35 in the horizontal direction and in the vertical direction. Namely, the laser beams are, so to speak, two-dimensionally scanned. Accordingly, the horizontal length of the stereoscopic image to be displayed may be enlarged without depending on the length of the ribbon arrays 32a, 32b, 32c formed on the GLV 32.

When the operation frequencies of the first and the second galvano-mirrors 34, 35 are 1 MHz, 200 lines may be scanned by the first galvano-mirror 34 in the horizontal direction even if 5,000 lines are scanned by the second galvano-mirror 35 in the vertical direction. Accordingly, as described above, when the GLV 32 on which 6,144 ribbons are formed with intervals of 5 ìm between each other is used, the horizontal length of the stereoscopic image to be displayed may be enlarged up to 6 m.

Because the amount of information to be processed naturally increases by leaps and bounds for the displaying of a stereoscopic image in a large size as described above, the practically realizable image size is limited depending on the performance of signal processing. The display apparatus 30 according to the present embodiment is sufficiently capable of displaying a stereoscopic image in the aforesaid degree of size. By alleviating the limitation due to the signal processing capability by, for example, utilizing parallel processing technique of computer apparatus having high operation performance, an extra-large three-dimensional image may also be displayed.

It is difficult to scan the laser beams precisely in the horizontal direction and in the vertical direction as shown in FIG. 6 because the first and the second galvano-mirrors 34, 35 are driven to rotate continuously in the present embodiment. Alternatively, by the change of scanning speeds of the first and the second galvano-mirrors 34, 35 in the display apparatus 30 as shown in FIG. 7, laser beams may be scanned obliquely. More specifically, for example, the laser beam may be scanned six times in the vertical direction by the second galvano-mirror 35 while the laser beam has been scanned once in the horizontal direction by the first galvano-mirror 34. However, because the one-dimensionally modulated laser beam is shifted in the horizontal direction while the laser beam is scanned in the vertical directions in this case, an amount of such shifting should be in consideration to drive the ribbon arrays 32a, 32b, 32c of the GLV 32.

In the display apparatus 30, by the aforesaid operation of the first and the second galvano-mirrors 34, 35, the laser beams are scanned in the horizontal direction and the vertical direction. Then, the scanned laser beams is incident on the Fourier transformation lens 36.

The Fourier transformation lens 36 makes the incident laser beams pass through it to transform them by the Fourier transformation. Then the Fourier transformation lens 36 makes the transformed laser beams be incident on the one-dimensional diffuser panel 37.

Alternatively, other types of lens may be employed in place of the Fourier transformation lens 36 as long as such lens can perform Fourier transformation on the desired light.

The one-dimensional diffuser panel 37 is disposed on a Fourier surface of the Fourier transformation lens 36, and the one-dimensional diffuser panel 37 makes the incident laser beams pass through to diffuse them one-dimensionally. Because the display apparatus 30 is provided with the one-dimensional diffuser panel 37, the display apparatus 30 slightly enlarges the visual field thereof in the vertical direction, and can make the discontinuities between the wavefronts of the laser beams that are scanned in the vertical directions inconspicuous, thereby realizing more natural stereoscopic effects.

Then, in the display apparatus 30, the laser beams passed through the one-dimensional diffuser panel 37 is projected on a projection plane as shown in FIG. 4, and a stereoscopic image G having horizontal parallax is displayed.

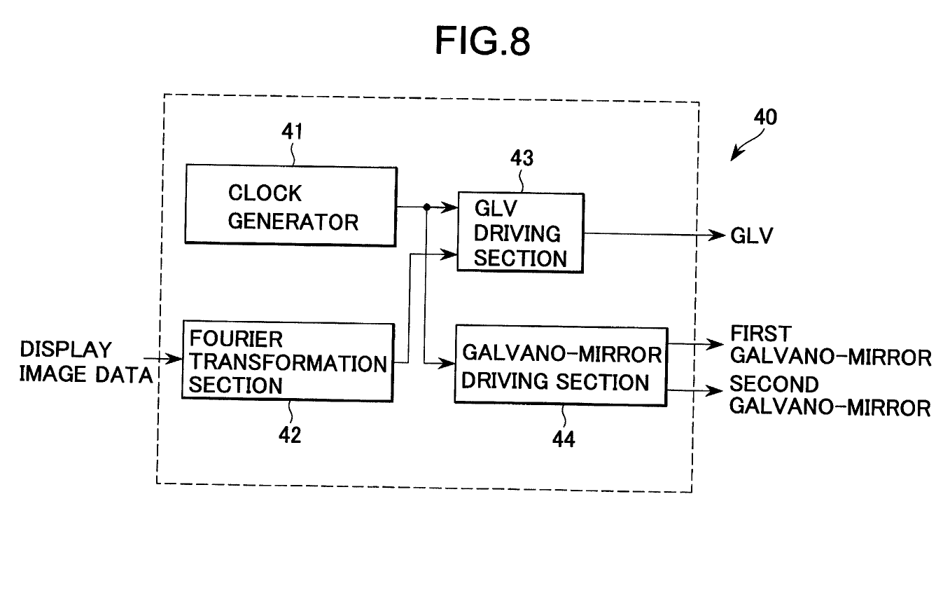

The display apparatus 30 comprises a control circuit 40 shown in FIG. 8. The control circuit 40 is constituted by, for example, various semiconductor devices. The information (hereinafter referred to as display image data) concerning stereoscopic images to be displayed is input into the control circuit 40. The information may be from an apparatus that may be located outside the display apparatus 30. The control circuit 40 controls the GLV 32 according to the input display image data to drive the plural ribbons formed on the GLV 32 separately. Moreover, the control circuit 40 controls the rotation speeds and the rotation timings of the first and the second galvano-mirrors 34, 35.

The control circuit 40 is, for example as shown in FIG. 8, comprises a clock generator 41, a Fourier transformation section 42, a GLV driving section 43, and a galvano-mirror driving section 44.

The clock generator 41 generates a clock signal being a reference of the operation timing of the control circuit 40, and the whole operation timing of the display apparatus 30. The clock generator 40 outputs the generated clock signal to the GLV driving section 43 and the galvano-mirror driving section 44. The signal level of the clock signal changes, for example, every predetermined time. Each section of the control circuit 40 performs various kinds of processing at the timing of the signal level change of the clock signal.

The Fourier transformation section 42 receives display image data from an external apparatus, and performs the Fourier transformation processing of the display image data. Then, the Fourier transformation section 42 outputs the data after performing the Fourier transformation processing to the GLV driving section 43.

The GLV driving section 43 operates at a timing based on the clock signal input from the clock generator 41, and controls the GLV 32 in accordance with the data input from the Fourier transformation section 42. That is, the GLV driving section 43 drives each ribbon formed on the GLV 32 to ascend or to descend, and sets each ribbon array 32a, 32b, 32c of the GLV 32 at a desired position that corresponds to a phase distribution in accordance with the input data.

The galvano-mirror driving section 44 controls the rotations of the first and the second galvano-mirror 34 according to the timing based on the clock signal input from the clock generator 41.

The control circuit 40 has the following control function. That is, by the operation of the GLV driving section 43 and the galvano-mirror driving section 44 according to the clock signal, the control circuit 40 makes the GLV 32 and the first and the second galvano-mirrors 34, 35 to operate at suitable timings in cooperation with each other. When the laser beams are scanned under the above cited control of the control circuit 40, an stereoscopic image is displayed in the display apparatus 30 as shown in FIG. 6 or FIG. 7.

The display apparatus 30 structured in such a way uses a micromachine type one-dimensional spatial modulator, i.e. the GLV 32, as a spatial modulator for modulating light to be projected. Because the GLV 32 can be operated at an extremely high speed, the stereoscopic image may be displayed while using sufficiently abundant amount of information. Moreover, because the display apparatus 30 displays the stereoscopic image with the light modulated by the GLV 32, the overall structure of the apparatus may be simplified, and the manufacturing cost thereof may be lowered. Moreover, stereoscopic effects may be expressed without using special equipment such as dedicated glasses for viewing a stereoscopic image.

Moreover, the display apparatus 30 modulates the laser beams with the GLV 32 having a function of an one-dimensional spatial modulator, and projects the modulated laser beams while scanning them to predetermined directions. Thereby, the display apparatus 30 displays the stereoscopic image. That is, the display apparatus 30 relinquishes the vertical parallax in the stereoscopic image to be displayed, and displays the stereoscopic image only with its horizontal parallax. Since the display apparatus 30 displays the stereoscopic image by utilizing only the horizontal parallax, the display apparatus 30 may suppress the increase of the amount of information necessary for displaying the stereoscopic image, and thereby it becomes possible to decrease the amount of information and the processing time, both being necessary for displaying the stereoscopic image.

In the above description, the display apparatus 30 scans the laser beams in the horizontal direction and in the vertical direction with using the first and the second galvano-mirrors 34, 35, and consequently the display apparatus 30 functions, so to speak, as a scan mechanism for scanning the laser beams.

The display apparatus 30 is not limited to be equipped with the scan mechanism structured in such a way. Alternatively, any scan mechanism structured to scan and project laser beams in predetermined directions may be employable.

More specifically, for example, the scan mechanism may be structured by the use of a two-axis galvano-mirror that is equipped with rotational axes orthogonal to each other and may drive a mirror two-dimensionally.

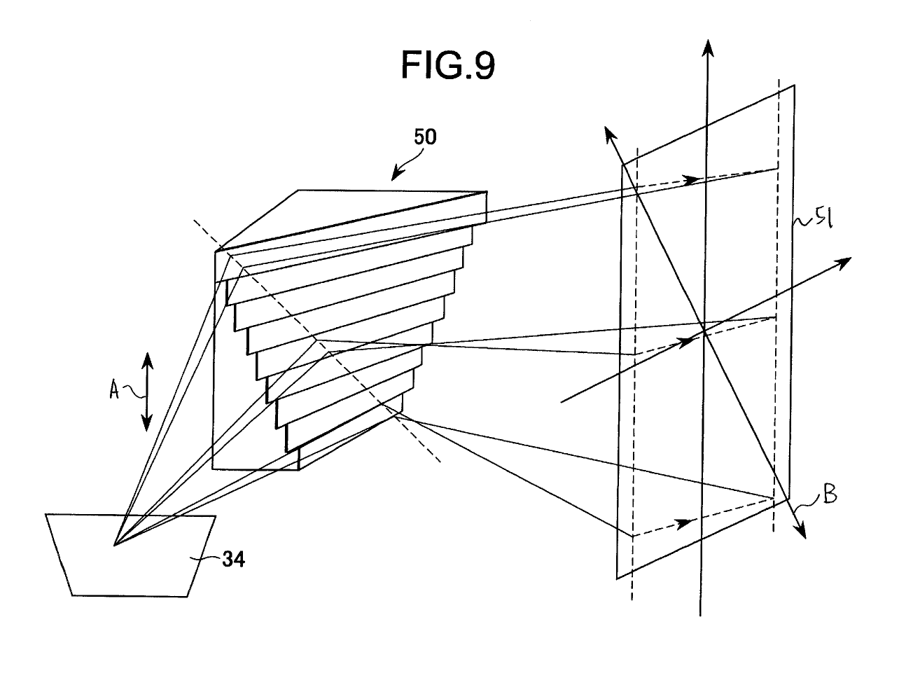

Moreover, still another type of the scan mechanism, a mirror array 50 shown in FIG. 9, may be used. In the mirror array 50, as shown in FIG. 9, surfaces on which the laser beams are incident upon are formed in a multistage shape. The reflection angle of each stage mirror is formed to differ from each other slightly. Then, by the use of the mirror array 50 in combination with, for example, the first galvano-mirror 34, the scanning with the scan mechanism is accomplished.

In this case, for example, by the rotation driving of the galvano-mirror 34 about the horizontal axis, the laser beams are scanned in the direction of an arrow A in FIG. 9, i.e. the vertical direction. Then, the laser beams are incident on the reflection surfaces of the mirror array 50, and thereby the laser beams are scanned in the direction of an arrow B in FIG. 9, namely the direction of a combination of the vertical direction and the horizontal direction, on a projection plane 51.

Moreover, in the display apparatus 30, the scan mechanism may be structured by the combination of, for example, a polygon mirror and a volume type hologram. Alternatively, the display apparatus may be structured to scan the laser beams by the rotation of the GLV 32 itself with utilizing a rotation mechanism such as a stepping motor.

Although the invention has been described in its preferred form with a certain degree of particularity, obviously many changes, variations and combinations of the embodiments are possible therein. It is therefore to be understood that the present invention may be practiced than as specifically described herein without departing from scope of the invention thereof.

What is claimed is:

1. A stereoscopic image display apparatus comprising:
a light source radiating light of a wavelength in a predetermined wavelength range;
a one-dimensional spatial modulator including one-dimensionally arrayed elements that are independently driven to generate an arbitrary phase distribution; and
a scan unit scanning the light to a predetermined direction, the light being from said light source, having entered into said one-dimensional spatial modulator and having been modulated therein.

2. The stereoscopic image display apparatus according to claim 1, wherein
said scan unit scans the light modulated by said one-dimensional spatial modulator in a direction perpendicular to an arraying direction of the elements of said one-dimensional spatial modulator.

3. The stereoscopic image display apparatus according to claim 1, wherein
said light source is provided with laser oscillators radiating laser beams having wavelengths in predetermined wavelength ranges severally corresponding to red, green and blue.

4. The stereoscopic image display apparatus according to claim 1, said apparatus further comprising:
a diffuser panel diffusing modulated light scanned by said scan unit.

5. The stereoscopic image display apparatus according to claim 1, wherein
said one-dimensional spatial modulator comprises a Grating Light Valve.

6. A stereoscopic image display apparatus comprising:
a light source radiating light having a wavelength in a predetermined wavelength range;
a Grating Light Valve device that can independently drive each ribbon-like element therein to generate an arbitrary phase distribution;
a collimator lens making the light modulated by said Grating Light Valve device into parallel ray;
a scan unit scanning the parallel ray coming from said collimator lens;
a lens performing Fourier transformation on the scanned ray; and
a diffuser panel diffusing the ray Fourier transformed by said lens.

7. A stereoscopic image display apparatus comprising:
means for radiating coherent light;
means for spatially modulating the coherent light in an one-dimensional direction to generate an arbitrary phase distribution; and
means for scanning the modulated light to a predetermined direction orthogonal to said one-dimensional direction.

8. A stereoscopic image display method comprising:
radiating coherent light;
spatially modulating the coherent light in an one-dimensional direction to generate an arbitrary phase distribution; and
scanning the modulated light to a predetermined direction orthogonal to said one-dimensional direction.
